(19) United States
(12) Patent Application Publication
(10) Pub. No.: US 2020/0065721 A1
(43) Pub. Date: Feb. 27, 2020

(54) INFORMATION PROCESSING APPARATUS, INFORMATION PROCESSING SYSTEM, AND INFORMATION PROCESSING METHOD

(71) Applicant: TOYOTA JIDOSHA KABUSHIKI KAISHA, Toyota-shi (JP)

(72) Inventors: Akihiko NAKANISHI, Nisshin-shi (JP); Daigo FUJII, Tsushima-shi (JP); Makoto TANAKA, Toyota-shi (JP); Kazuki TAKEUCHI, Toyota-shi (JP); Chie KOIKE, Nagoya-shi (JP); Daiki KANEICHI, Nisshin-shi (JP); Tsuyoshi OKADA, Toyota-shi (JP)

(73) Assignee: TOYOTA JIDOSHA KABUSHIKI KAISHA, Toyota-shi (JP)

(21) Appl. No.: 16/529,170

(22) Filed: Aug. 1, 2019

(30) Foreign Application Priority Data
Aug. 21, 2018 (JP) 2018-154729

(51) Int. Cl. G06Q 10/02; G06Q 50/30; G06Q 20/40

(52) U.S. Cl. CPC G06Q 10/02; G06Q 20/407; G06Q 50/30

(57) ABSTRACT

An information processing apparatus includes a processor. The processor is configured to manage reservation for a transport service for sharing a ride in a vehicle that travels to a predetermined destination; receive a cancellation request for a first reservation for the transport service provided using a first vehicle, from a user terminal of a first user who is one of a driver user of the first vehicle or a passenger user who is scheduled to get on board the first vehicle, for whom the first reservation is established; and determine a substitute driver user or a substitute passenger user for the first user, and assign a penalty to the first user, in a case where the cancellation request for the first reservation is received from the user terminal of the first user.

### CROSS REFERENCE TO RELATED APPLICATION

This application claims the benefit of Japanese Patent Application No. 2018-154729, filed on Aug. 21, 2018, which is hereby incorporated by reference herein in its entirety.

### BACKGROUND

### Technical Field

The present disclosure relates to an information processing apparatus, an information processing system, and an information processing method.

### Description of the Related Art

In recent years, use of so-called ride-sharing, which is a mode of transport in which a plurality of users share a ride in a same vehicle, is becoming widespread. Furthermore, a technology for matching a plurality of users for use of such ride-sharing is being developed.

Moreover, Patent document 1 discloses a technology for determining whether holders of terminals are sharing a ride in a same vehicle or not.

### CITATION LIST

### Patent Document

Patent document 1: Japanese Patent Laid-Open No. 2011-237842

The present disclosure has its object to provide an information processing apparatus, an information processing system, and an information processing method which are capable of suppressing inconsiderate cancellation of reservation with respect to a transport service for sharing ride in a vehicle that travels to a predetermined destination, and of reducing a damage to a party receiving cancellation of the reservation.

### SUMMARY

An aspect of the present disclosure is an information processing apparatus including a processor configured to:

manage reservation for a transport service for sharing a ride in a vehicle that travels to a predetermined destination;

receive a cancellation request for a first reservation for the transport service provided using a first vehicle, from a user terminal of a first user who is one of a driver user of the first vehicle or a passenger user who is scheduled to get on board the first vehicle, for whom the first reservation is established; and

determine a substitute driver user or a substitute passenger user for the first user, and assign a penalty to the first user, in a case where the cancellation request for the first reservation is received from the user terminal of the first user.

Another aspect of the present disclosure is an information processing system including one or a plurality of processors configured to:

manage reservation for a transport service for sharing a ride in a vehicle that travels to a predetermined destination;

receive a cancellation request for a first reservation for the transport service provided using a first vehicle, from a user terminal of a first user who is one of a driver user of the first vehicle or a passenger user who is scheduled to get on board the first vehicle, for whom the first reservation is established; and

determine a substitute driver user or a substitute passenger user for the first user, and assign a penalty to the first user, in a case where the cancellation request for the first reservation is received from the user terminal of the first user.

Another aspect of the present disclosure is an information processing method including:

managing reservation for a transport service for sharing a ride in a vehicle that travels to a predetermined destination;

receiving a cancellation request for a first reservation for the transport service provided using a first vehicle, from a user terminal of a first user who is one of a driver user of the first vehicle or a passenger user who is scheduled to get on board the first vehicle, for whom the first reservation is established; and

determining a substitute driver user or a substitute passenger user for the first user, and assigning a penalty to the first user, in a case where the cancellation request for the first reservation is received from the user terminal of the first user.

According to the present disclosure, inconsiderate cancellation of reservation may be suppressed with respect to a transport service for sharing a ride in a vehicle that travels to a predetermined destination, and a damage to a party receiving cancellation of the reservation may be reduced.

### BRIEF DESCRIPTION OF DRAWINGS

FIG. 1 is a diagram illustrating an example of a system configuration of a ride-sharing service providing system according to a first embodiment;

FIG. 2 is a diagram illustrating an example of a hardware configuration of the center server;

FIG. 3 is a diagram illustrating a functional configuration of the center server;

FIG. 4 is a diagram illustrating an example of a data structure of the user information DB;

FIG. 5 is a diagram illustrating an example of a data structure of the ride-seeking user schedule information

DB;

FIG. 6 is a diagram illustrating an example of a data structure of the driver user schedule information DB;

FIG. 7 is a diagram illustrating an example of a data structure of the reservation information DB;

FIG. 8 is a diagram illustrating an example of rank information;

FIG. 9 is an example of a flowchart of a ride reservation process by the center server according to the first embodiment;

FIG. 10A is a diagram illustrating an example of a flowchart of a cancellation process by the center server according to the first embodiment; and

FIG. 10B is a diagram illustrating an example of a flowchart of a cancellation process by the center server according to the first embodiment.

### DESCRIPTION OF THE EMBODIMENTS

An embodiment is an information processing apparatus including a processor configured to: manage reservation for a transport service for sharing a ride in a vehicle that travels to a predetermined destination; receive a cancellation request for a first reservation for the transport service provided using a first vehicle, from a user terminal of a first user who is one of a driver user of the first vehicle or a passenger user who is scheduled to get on board the first vehicle, for whom the first reservation is established; and determine a substitute driver user or a substitute passenger user for the first user, and assign a penalty to the first user, in a case where the cancellation request for the first reservation is received from the user terminal of the first user. In the case where the first user is the driver user, a substitute driver user for the first user is determined. In the case where the first user is the passenger user, a substitute passenger user for the first user is determined.

The penalty that is assigned to the first user may be any of cancellation charges, a reduction or an increase in a fee for subsequent use of the transport service, and a lower priority ranking for reservation for the transport service. A reduction in the fee for subsequent use of the transport service may be applied in a case where the first user cancelling the first reservation is the driver user, for example. The fee for using the transport service that is paid to the driver user is thereby reduced.

In relation to cancellation of a reservation for the transport service, an influence on the user receiving the cancellation may be reduced by determining a substitute driver user or a substitute passenger user for the user receiving the cancellation. Furthermore, because a penalty is assigned to the first user who makes cancellation, inconsiderate cancellation of a reservation for the transport service may be suppressed.

Moreover, in an embodiment, in the case where a substitute user for the first user is not found, an incentive may be assigned to the user receiving cancellation of the first reservation. Reduction in willingness of the user receiving cancellation of the first reservation to use the transport service may thereby be suppressed.

Furthermore, in an embodiment, in the case where the first user who cancels the first reservation is the driver user, the processor may determine, as the substitute driver user for the first user, a driver user of a second vehicle on which a first passenger user of the first reservation is to board, and in the case where capacity of the second vehicle is to be exceeded by boarding of the first passenger user on the second vehicle, the processor may transmit, to a user terminal of a second passenger user for whom a second reservation for boarding the second vehicle is established, a cancellation appeal for the second reservation and information about an incentive that is assigned to the second passenger user in a case of cancellation of the second reservation. The incentive may be any of a higher priority ranking for reservation for the transport service, and assignment of a point or a coupon.

Preferential boarding on another vehicle may thereby be arranged for the first passenger user who received cancellation of the first reservation. Moreover, because information about an incentive is transmitted together with the cancellation appeal for the second reservation, a passenger user who is willing to cancel the second reservation may be more easily recruited.

In the following, an embodiment of the present disclosure will be described with reference to the drawings. The configuration of the embodiment described below is an example, and the present disclosure is not limited to the configuration of the embodiment.

### First Embodiment

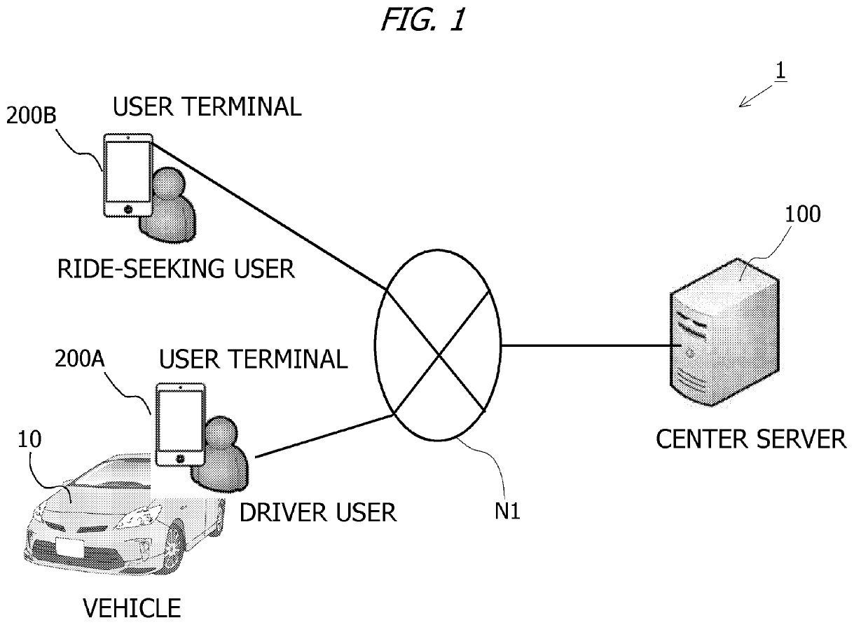

FIG. 1 is a diagram illustrating an example of a system configuration of a ride-sharing service providing system 1 according to a first embodiment. A ride-sharing service is a service for providing sharing of transport by a vehicle by matching a vehicle (or a driver of the vehicle) which is scheduled to move to a predetermined destination and a user whose destination is in a same direction as the aforementioned destination, and by causing the user to get a lift in the vehicle. For example, predetermined compensation is paid to the driver of the vehicle. A predetermined fee is collected from the user getting a lift in the vehicle, for example. The compensation that is paid to the driver of the vehicle is money, or points or coupons that can be used for predetermined services, for example. Money is paid in cash, is deposited into a predetermined bank account, or is paid in electronic money, for example. The ride-sharing service is an example of a “transport service for sharing a ride in a vehicle that travels to a predetermined destination”.

The ride-sharing service providing system 1 includes a vehicle 10, a user terminal 200A held by a driver user who is a driver of the vehicle 10, a user terminal 200B of a ride-seeking user who wishes to get a ride in the vehicle 10 as a non-driver user, and a center server 100. A plurality of vehicles 10, a plurality of user terminals 200A, and a plurality of user terminals 200B are included in the ride-sharing service providing system 1, but for the sake of simplicity, FIG. 1 extracts and illustrates one each of the above. Furthermore, in the case of not distinguishing between the user terminal 200A and the user terminal 200B, a term “user terminal 200” will be simply used. The driver user is an example of a “driver user”. The ride-seeking user is an example of a “passenger user”.

Each user terminal 200 and the center server 100 are connected to a network N1, and are connected to each other over the network N1. For example, as the network N1, a wide area network (WAN), which is a worldwide public communication network such as the Internet, or other communication networks may be adopted. Furthermore, the network N1 may include a mobile communication network for mobile phones, or a wireless communication network such as Wi-Fi.

For example, the driver user and the ride-seeking user are users who have an application, which is provided by the ride-sharing service providing system 1, installed in the user terminals 200, and who are registered as the driver user or the ride-seeker user through the application. For example, the user terminal 200 is a mobile terminal such as a smartphone, a tablet terminal, a laptop personal computer (PC), or a mobile phone terminal.

The driver user registers, in the center server 100, schedule information about a traveling schedule of the vehicle 10, through the user terminal 200A. The ride-seeking user transmits a ride reservation request to the center server 100 through the user terminal 200B. Schedule information on which the ride-seeking user wishes to travel by the vehicle 10 is transmitted together with the ride reservation request. The schedule information includes a departure point, a destination, a scheduled departure time or a desired departure time (in the case of the passenger user), and a scheduled arrival time or a desired arrival time (in the case of the passenger user), for example.

When the ride reservation request is received from the user terminal 200B of the ride-seeking user, the center server 100 checks the schedule information on the ride-seeking user against the schedule information on the driver user that is registered in advance, and determines the driver user who is to give a ride to the ride-seeking user. Determination of the driver user (or the vehicle 10) who is to give a ride to the ride-seeking user, based on the schedule information, or determination of the ride-seeking user who is to get on board the vehicle 10 of the driver user, based on the schedule information, is referred to as “matching”.

For example, the center server 100 determines, on the basis of the schedule information on the ride-seeking user and the driver user who are matched, a scheduled meet-up location and a scheduled meet-up time for the two parties. The center server 100 transmits the ride reservation request to the user terminal 200A of the matched driver user, and asks the matched driver user for confirmation. Identification information on a ride reservation and contents of the ride reservation are also transmitted to the user terminal 200A of the driver user, together with the ride reservation request. Contents of a ride reservation includes information about the ride-seeking user, the scheduled meet-up location, the scheduled meet-up time, the destination of the ride-seeking user, and the scheduled arrival time at the destination, for example. Information about the ride-seeking user includes a user name, a gender, an age range, contact information (a telephone number, an email address), and the like of the ride-seeking user, for example.

When the center server 100 receives an OK response to the ride reservation request, from the user terminal 200A of the driver user, the ride reservation is established. When the ride reservation is established, the center server 100 transmits a notification indicating ride reservation establishment to the user terminal 200B of the ride-seeking user who is a transmission source of the ride reservation request. The identification information on the ride reservation and contents of the ride reservation are also transmitted to the user terminal 200B of the ride-seeking user, together with the notification indicating ride reservation establishment. For example, the contents of the ride reservation include information about the driver user, the scheduled meet-up location, the scheduled meet-up time, the destination of the ride-seeking user, and the scheduled arrival time at the destination. Information about the driver user includes a user name, a gender, an age range, contact information (a telephone number, an email address), and the like of the driver user, and information about the vehicle 10, for example. Information about the vehicle 10 may be an image of the vehicle 10, or may be information about an external appearance of the vehicle 10, such as a model, a color, or a vehicle identification number of the vehicle 10, for example.

Now, a ride reservation is sometimes cancelled by the driver user or the ride-seeking user between ride reservation establishment and start of the service for the ride reservation, due to the driver user or the ride-seeking user feeling ill or due to an unexpected plan, for example. When a ride reservation is cancelled, the schedule of the user receiving cancellation is also changed, thereby causing damage. Damage is especially significant in the case of cancellation immediately before the scheduled meet-up time of the ride reservation.

Accordingly, in the first embodiment, in the case where there is a cancellation of a ride reservation, the center server 100 newly performs matching to find a substitute ride-seeking user or a substitute driver user for the driver user or the ride-seeking user who received the cancellation. Accordingly, in the case where the user receiving cancellation is the driver user, compensation which is to be obtained by the cancelled ride reservation may be supplemented. Moreover, in the case where the user receiving cancellation is the ride-seeking user, transport to the destination by the ride reservation which is cancelled may be supplemented. That is, a disadvantage caused to the user receiving cancellation may be countered.

Moreover, in the first embodiment, in the case where there is a cancellation of the ride reservation, the center server 100 assigns a penalty to the user who makes the cancellation. The penalty to the user who makes the cancellation may be payment of cancellation charges, collection of owned points, a lower priority ranking for ride reservation, a reduction in the fee for subsequent use of ride-sharing service (in the case of the driver user) or an increase in the fee (in the case of the ride-seeking user), and the like, for example. A priority ranking for ride reservation is a member rank that is determined according to the number of times of use of the ride-sharing service, for example. Inconsiderate cancellation of a ride reservation may thus be suppressed.

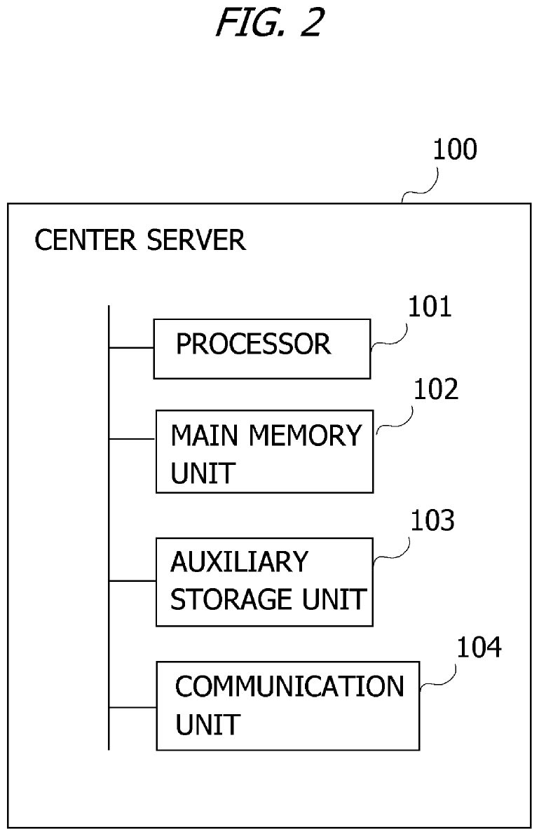

FIG. 2 is a diagram illustrating an example of a hardware configuration of the center server 100. For example, the center server 100 is a dedicated computer or a general-purpose computer. The center server 100 includes, as hardware components, a processor 101, a main memory unit 102, an auxiliary storage unit 103, and a communication unit 104. These are interconnected by a bus. The main memory unit 102 and the auxiliary storage unit 103 are computer-readable recording media. The center server 100 is an example of an “information processing apparatus”.

The auxiliary storage unit 103 stores various programs, and data to be used by the processor 101 at the time of execution of each program. For example, the auxiliary storage unit 103 is an erasable programmable ROM (EPROM) or a hard disc drive. Programs held by the auxiliary storage unit 103 include an operating system (OS), a ride-sharing service control program, and other various application programs. The ride-sharing control program is a program for management of a ride reservation for the ride-sharing service, user management, and the like.

The main memory unit 102 is a main memory that provides a work area and a storage area where programs stored in the auxiliary storage unit 103 are loaded by the processor 101, or that is used as a buffer, for example. The main memory unit 102 includes a semiconductor memory such as a read only memory (ROM) or a random access memory (RAM), for example.

For example, the processor 101 is a central processing unit (CPU). The processor 101 performs various processes by loading the OS and various application programs held in the auxiliary storage unit 103 into the main memory unit 102 and executing the same. A plurality of processors 101 may be provided without being limited to one. The processor 101 is an example of a “processor”.

The communication unit 104 is an interface used for input/output of information with a network. The communication unit 104 may be an interface that connects to a wired network, or may be an interface that connects to a wireless network. For example, the communication unit 104 is a network interface card (NIC) or a wireless circuit.

Additionally, the hardware configuration of the center server 100 illustrated in FIG. 2 is an example and is not limited to the above, and omission, replacement, and addition of structural elements may be performed as appropriate according to the embodiment. For example, the center server 100 may include a removable recording medium drive device, and may execute programs recorded in a removable recording medium. The removable recording medium is a recording medium such as an SD card, a mini SD card, a micro SD card, a universal serial bus (USB) flash memory, a compact disc (CD), a digital versatile disc (DVD), a Blu-ray (registered trademark) disc, or a flash memory card, for example. Moreover, the center server 100 may include an input device and an output device, for example. The input device is a keyboard, a mouse, or a touch panel, for example. The output device is a display, for example.

Additionally, a series of processes to be performed by the center server 100 is not limited to be performed by execution of software by the processor 101, and may alternatively be performed by hardware such as a field-programmable gate array (FPGA), for example.

Illustration of a hardware configuration of the user terminal 200 is omitted. In addition to the processor, the main memory unit, the auxiliary storage unit, and the communication unit described above, the user terminal 200 includes a display unit, an input unit, and the like. For example, the display unit is a liquid crystal display (LCD) or an electroluminescence (EL) panel. The input unit includes a touch panel, push buttons, and the like. The input unit may further include a camera enabling input of videos and images, and an input unit for audio, such as a microphone. The communication unit is a communication circuit for accessing the network N1 by using a mobile communication network for mobile phones, or wireless communication such as Wi-Fi, for example. The user terminal 200 transmits a ride reservation request, schedule information, user information, and the like to the center server 100 on the basis of an operation input to an application performed by a user through the input unit.

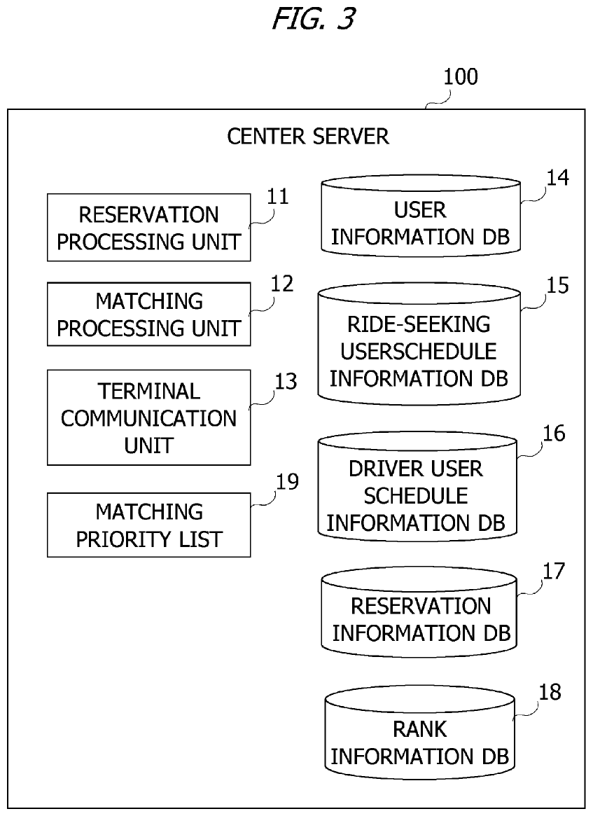

FIG. 3 is a diagram illustrating a functional configuration of the center server 100. The center server 100 includes, as functional structural elements, a reservation processing unit 11, a matching processing unit 12, a terminal communication unit 13, a user information database (DB) 14, a ride-seeking user schedule information DB 15, a driver user schedule information DB 16, a reservation information DB 17, a rank information DB 18, and a matching priority list 19. These functional structural elements are implemented by the processor 101 of the center server 100 executing the ride-sharing service control program stored in the auxiliary storage unit 103, for example.

The terminal communication unit 13 is an interface to the user terminal 200. The terminal communication unit 13 exchanges data with the user terminal 200 through the communication unit 104. An example of data that is received by the terminal communication unit 13 from the user terminal 200 is the ride reservation request or a cancellation request for a ride reservation. The terminal communication unit 13 outputs the data received from the user terminal 200, to the reservation processing unit 11.

The reservation processing unit 11 performs control regarding ride reservation. Details of processing by the reservation processing unit 11 are as follows, for example. In the case where user information is received from the user terminal 200 through the terminal communication unit 13, the reservation processing unit 11 stores the received user information in the user information DB 14 described later. In the case where schedule information is received from the user terminal 200A of the driver user through the terminal communication unit 13, the reservation processing unit 11 stores the schedule information in the driver user schedule information DB 16 described later.

In the case where a ride reservation request is received from the user terminal 200B of the ride-seeking user through the terminal communication unit 13, the reservation processing unit 11 requests the matching processing unit 12 to perform matching. The schedule information on the ride-seeking user is also received from the user terminal 200B of the ride-seeking user, together with the ride reservation request. The schedule information on the ride-seeking user is stored in the ride-seeking user schedule information DB 15 by the reservation processing unit 11.

For example, the reservation processing unit 11 receives, from the matching processing unit 12, input of information about the driver user who is matched with the ride-seeking user of the user terminal 200B, and the scheduled meet-up location and the scheduled meet-up time. The reservation processing unit 11 transmits the ride reservation request to the user terminal 200A of the matched driver user, through the terminal communication unit 13. Identification information on the ride reservation and contents of the ride reservation are also transmitted together with the ride reservation request.

In the case where an OK response to the ride reservation request is received from the user terminal 200A of the driver user through the terminal communication unit 13, the reservation processing unit 11 determines establishment of the ride reservation, and registers ride reservation information in the reservation information DB 17. Moreover, the reservation processing unit 11 transmits a notification indicating ride reservation establishment to the user terminal 200B which is the transmission source of the ride reservation request, through the terminal communication unit 13. For example, identification information on the ride reservation and contents of the ride reservation are also transmitted to the user terminal 200B which is the transmission source of the ride reservation request, together with the notification indicating ride reservation establishment.

For example, in the case where a cancellation request for a ride reservation is received from the user terminal 200, the reservation processing unit 11 performs a cancellation process for the corresponding ride reservation. An identification number of the cancellation-target ride reservation is also received together with the cancellation request for the ride reservation. For example, in the cancellation process for a ride reservation, the reservation processing unit 11 deletes information about the corresponding ride reservation from the reservation information DB 17, and transmits a cancellation notification regarding the ride reservation to the user terminals 200 of the user who cancelled the ride reservation and the user who received the cancellation. For example, in the case where the cancellation request for the ride reservation is received from the user terminal 200A of the driver user, the cancellation notification regarding the ride reservation is transmitted to the user terminal 200B of the ride-seeking user of the target ride reservation and the user terminal 200A of the driver user in question. In the case where the ride-seeking user still wishes to use the ride-sharing service for the cancelled schedule information, the ride reservation request may be transmitted again to the center server 100 from the user terminal 200B.

However, for example, in the case where, when a cancellation request for a ride reservation is received, a time point which is a predetermined time before the schedule meet-up time of the cancellation-target ride reservation is already passed, an influence on the schedule of the party receiving the cancellation is great, and thus, the reservation processing unit 11 performs the following process. For example, the predetermined time before the scheduled meet-up time of a ride reservation is one day before, one hour before, or the like, and may be freely set by an administrator of the ride-sharing service providing system 1. Furthermore, in the case where the target of a cancellation request from the driver user includes ride schedules of a plurality of ride-seeking users, an earliest scheduled meet-up time of the plurality of ride reservations, which are targets of the cancellation request, is taken as a reference.

The reservation processing unit 11 requests the matching processing unit 12 to newly perform matching, to find a substitute ride-seeking user or a substitute driver user for the driver user or the ride-seeking user who received cancellation of the cancellation-target ride reservation. For example, in the case where there is a cancellation request for a ride reservation from the driver user, and a substitute driver user is not found by matching for the ride-seeking user who received the cancellation, an incentive may be assigned to the ride-seeking user. For example, an incentive that is assigned to the ride-seeking user may be a prior right for ride reservation, a promotion in the member rank, assignment of points or coupons, or the like.

Furthermore, for example, in the case where there is a cancellation request from the ride-seeking user, and a substitute ride-seeking user is not found by matching for the driver user who received the cancellation, the reservation processing unit 11 registers the driver user in the matching priority list 19.

For example, the matching priority list 19 is held in the auxiliary storage unit 103 of the center server 100. Identification information on the driver user who received cancellation of a ride reservation and schedule information on the cancelled ride reservation are registered in the matching priority list 19. The scheduled meet-up location, the scheduled meet-up time, the destination, and the scheduled arrival time of the cancelled ride reservation are included in the schedule information that is registered in the matching priority list, as a departure point, a scheduled departure time, a destination, and a scheduled arrival time, respectively.

In the case where the reservation processing unit 11 receives a ride reservation request from the user terminal 200B of the ride-seeking user and the schedule information that is received together with the ride reservation is similar to schedule information that is registered in the matching priority list 19, the reservation processing unit 11 performs matching between the driver user who is registered in the matching priority list 19 and the ride-seeking user of the ride reservation request, without requesting the matching processing unit 12 to perform matching. A substitute ride-seeking user is thus allocated to the driver user who received cancellation of the ride reservation.

Additionally, that the schedule information that is received together with the ride reservation is similar to schedule information that is registered in the matching priority list 19 means that the departure points and arrival points of the two are present in a predetermined geographical range, and that the schedule departure times and the scheduled arrival times are within a predetermined time range. Registration of the driver user in the matching priority list 19 is an example of assignment of an incentive to the driver user who received cancellation of a ride reservation. Additionally, the incentive that is assigned to a driver in the case where there is a cancellation request from the ride-seeking user and a substitute ride-seeking user is not found by matching for the driver user who received the cancellation is not limited to the above. For example, the incentive that is assigned to the driver user may be a promotion in the member rank, assignment of points or coupons, or the like.

On the other hand, for example, in the case where there is a cancellation request from the driver user, the reservation processing unit 11 requests the matching processing unit 12 to newly perform matching for the ride-seeking user of the cancellation-target ride reservation. In the case where capacity of the vehicle 10 matched with the ride-seeking user is exceeded as a result of matching by the matching processing unit 12, the reservation processing unit 11 transmits a cancellation appeal for a ride reservation to the user terminal(s) of the ride-seeking user(s) with a ride reservation for the vehicle 10, to recruit a ride-seeking user who is willing to cancel the ride reservation for the vehicle 10. Identification information on the target ride reservation and information on the incentive that is assigned to the ride-seeking user upon cancellation of the ride reservation are transmitted together with the cancellation appeal for the ride reservation.

For example, the incentive that is assigned to the ride-seeking user upon cancellation of a ride reservation in response to a cancellation appeal for the ride reservation is points that can be used for predetermined services including the ride-sharing service, a coupon that can be used in subsequent uses, a promotion in the member rank, and the like. A promotion in the member rank is an example of a higher priority ranking for reservation for the transport service.

In the case where, when a cancellation request for a ride reservation is received, a time point which is a predetermined time before the schedule meet-up time of the cancellation-target ride reservation is already passed, the reservation processing unit 11 assigns a penalty to the driver user or the ride-seeking user who is the transmission source of the cancellation request for the ride reservation. For example, the penalty that is assigned to the user who cancelled a ride reservation may be collection of fines, collection of points held by the user, a lowered member rank, an increase in the fee for subsequent use of the ride-sharing service (in the case of the passenger user) or a reduction in the fee (in the case of the driver user), or in the case of the driver user, removal from the matching priority list 19.

The matching processing unit 12 performs matching between the ride-seeking user corresponding to the user terminal 200B which is the transmission source of a ride reservation request, and the driver user, in response to a request from the reservation processing unit 11. The method of matching by the matching processing unit 12 may be any known technique, and is not limited to a specific method. For example, the matching processing unit 12 extracts, from the driver user schedule information DB 16 described later, the schedule information on a driver user including a period from a desired departure time to a desired arrival time in the schedule information on the ride-seeking user received together with the ride reservation request, and including, at or near the destination or a via point, a departure point and a destination of the ride-seeking user. The matching processing unit 12 selects a matching counterpart of the ride-seeking user randomly or on the basis of an evaluation value, an attribute or the like, from driver users of extracted schedule information pieces.

Furthermore, the matching processing unit 12 determines a scheduled meet-up location on the basis of the departure point and the destination of the ride-seeking user, and the destination and the via point of the driver user, for example. Furthermore, the matching processing unit 12 determines a scheduled meet-up time on the basis of the desired departure time and the desired arrival time of the ride-seeking user and other ride reservations for the driver user. The method for determining the scheduled meet-up location and the scheduled meet-up time may be any known technique, and is not limited to a specific method. The matching processing unit 12 outputs information about the selected driver user, the scheduled meet-up location, the scheduled meet-up time, and the like to the reservation processing unit 11.

Additionally, processes by the reservation processing unit 11, the matching processing unit 12, and the terminal communication unit 13 may be performed by separate computers.

The user information DB 14, the ride-seeking user schedule information DB 15, the driver user schedule information DB 16, the reservation information DB 17, and the rank information DB 18 are each constructed by management of data stored in the auxiliary storage unit 103 by a program, in a database management system (DBMS), that is executed by the processor 101, for example. The user information DB 14, the ride-seeking user schedule information DB 15, the driver user schedule information DB 16, the reservation information DB 17, and the rank information DB 18 are relational databases, for example.

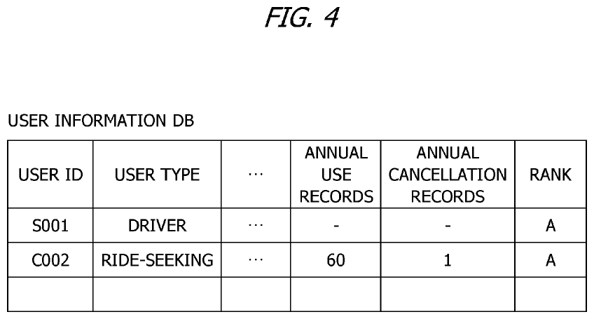

FIG. 4 is a diagram illustrating an example of a data structure of the user information DB 14. Information about a user is stored in the user information DB 14. For example, information about a user that is stored in the user information DB 14 includes a user ID, a user type, attribute information on a user, contact information on the user, and in the case where the user is the driver user, a vehicle ID, external vehicle appearance information, a capacity of the vehicle, and the like. In FIG. 4, a part of the information about a user stored in the user information DB 14 is extracted and illustrated.

FIG. 4 illustrates fields, in the information about a user stored in the user information DB 14, of the user ID, the user type, annual use records, annual cancellation records, and the rank. In the field of user type, information indicating the driver user or the ride-seeking user is input. In the field of annual use records, the number of times of use of the ride-sharing service in an immediately preceding year is stored. In the case of the ride-seeking user, the number of times of use is the number of times of transport by the vehicle 10 registered in the ride-sharing service. In the case of the driver user, the number of times of use is a total number of ride-seeking users transported by the vehicle 10.

In the field of annual cancellation records, the number of times of cancellation made or the number of ride reservations cancelled after a time point which is a predetermined time before the scheduled meet-up time is already passed, in an immediately preceding year, is input. In the field of rank, the member rank of the user is input. Details of the member rank will be described later.

A value in each field in the user information DB 14 is registered, updated, or deleted by the reservation processing unit 11, for example. Additionally, the data structure of the user information DB 14 is not limited to the one illustrated in FIG. 4.

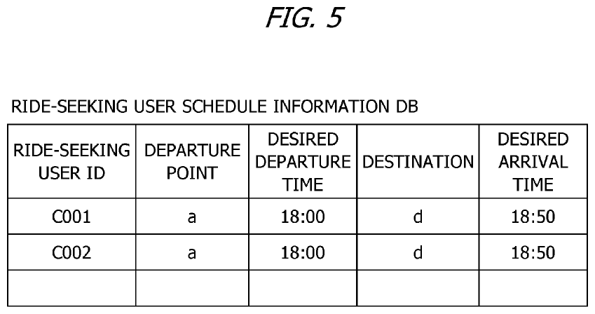

FIG. 5 is a diagram illustrating an example of a data structure of the ride-seeking user schedule information DB 15. The ride-seeking user schedule information DB 15 is a database storing the schedule information on the ride-seeking user. The ride-seeking user schedule information DB 15 illustrated in FIG. 5 includes fields of a user ID, a departure point, a desired departure time, a destination, and a desired arrival time.

In the field of user ID, user identification information on the ride-seeking user is input. In the fields of departure point and destination, any of an address or latitude/longitude of the departure point and the destination is input, for example. In the fields of desired departure time and desired arrival time, year, month, date, and time are input.

Information stored in the ride-seeking user schedule information DB 15 is registered, updated, or deleted by the reservation processing unit 11. For example, when schedule information is received from the user terminal 200B of the ride-seeking user, together with a ride reservation request, the schedule information is registered, as a new entry, in the ride-seeking user schedule information DB 15 by the reservation processing unit 11. Moreover, when the corresponding ride reservation is fulfilled, the corresponding entry may be deleted from the ride-seeking user schedule information DB 15. Additionally, information that is stored in the ride-seeking user schedule information DB 15 is not limited to the example illustrated in FIG. 5, and fields may be added, changed or deleted as appropriate.

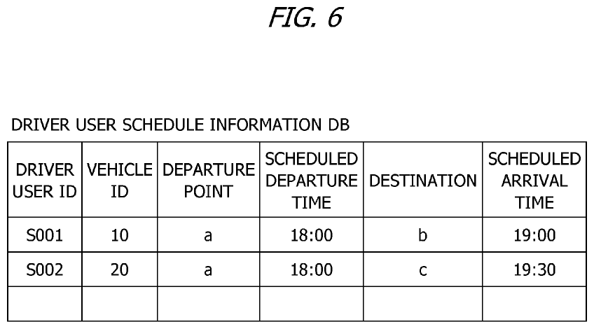

FIG. 6 is a diagram illustrating an example of a data structure of the driver user schedule information DB 16. The driver user schedule information DB 16 is a database storing schedule information on the driver user. The driver user schedule information DB 16 illustrated in FIG. 6 includes fields of a user ID, a departure point, a vehicle ID, a scheduled departure time, a destination, and a scheduled arrival time.

In the field of user ID, user identification information on the driver user is input. In the field of vehicle ID, identification information on the vehicle 10 is input. In the fields of departure point and destination, an address or latitude/longitude of the departure point or the destination is input. In the fields of scheduled departure time and scheduled arrival time, year, month, date, and time are input. Additionally, information about the vehicle 10 is stored in another database. Information about the vehicle 10 is the identification information on the vehicle, the identification information on the driver user, a model, a color, and capacity, for example.

Information stored in the driver user schedule information DB 16 is registered, updated, or deleted by the reservation processing unit 11. For example, when schedule information is received from the user terminal 200A of the driver user, the schedule information is registered, as a new entry, in the driver user schedule information DB 16 by the reservation processing unit 11. The entry may be deleted from the driver user schedule information DB 16 after a lapse of a predetermined time from the scheduled arrival time in the schedule information. Additionally, information that is stored in the driver user schedule information DB 16 is not limited to the example illustrated in FIG. 6, and fields may be added, changed or deleted as appropriate.

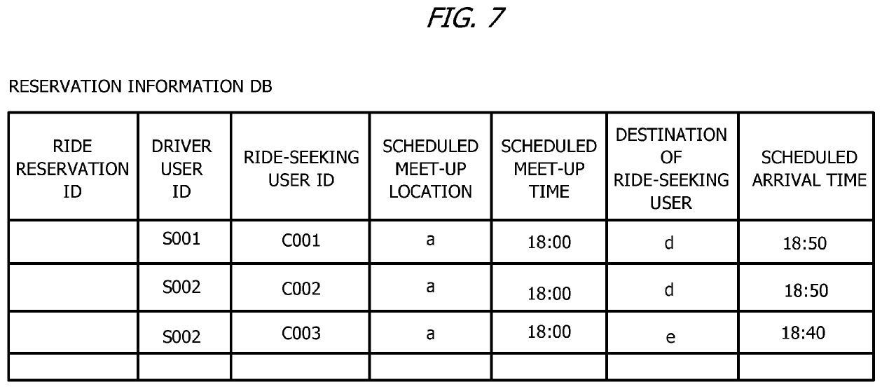

FIG. 7 is a diagram illustrating an example of a data structure of the reservation information DB 17. The reservation information DB 17 is a database holding information about a ride reservation.

The reservation information DB 17 illustrated in FIG. 7 includes a ride reservation ID, a driver user ID, a ride-seeking user ID, a scheduled meet-up location, a scheduled meet-up time, a destination of the ride-seeking user, and a scheduled arrival time. In the field of ride reservation ID, identification information on a ride reservation is input. Identification information on a ride reservation is assigned by the reservation processing unit 11, when a ride reservation request is received from the user terminal 200B, for example. In the field of driver user ID, identification information on the driver user is input. In the field of ride-seeking user ID, identification information on the ride-seeking user is input.

In the field of scheduled meet-up location, information about the scheduled meet-up location determined by the matching processing unit 12 is input. In the scheduled meet-up location field, any of latitude/longitude, an address, and the name of a landmark may be input as information about the scheduled meet-up location, for example. In the field of scheduled meet-up time, the scheduled meet-up time determined by the matching processing unit 12 is input.

For example, information that is stored in the fields of destination and scheduled arrival time of the ride-seeking user is input on the basis of the schedule information on the ride-seeking user.

Information stored in the reservation information DB 17 is registered, updated, or deleted by the reservation processing unit 11. For example, when a ride reservation is established, a new entry is registered in the reservation information DB 17 by the reservation processing unit 11. Furthermore, when a cancellation request is received from the user terminal 200, an entry for the cancellation target is deleted from the reservation information DB 17 by the reservation processing unit 11. Additionally, information that is stored in the reservation information DB 17 is not limited to the example illustrated in FIG. 7, and fields may be added, changed or deleted as appropriate.

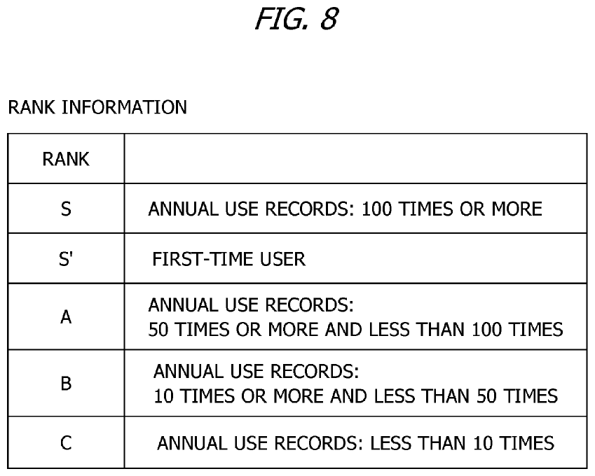

FIG. 8 is a diagram illustrating an example of rank information. Rank information stores definitions of member ranks, and is stored in the rank information DB 18. In the first embodiment, five stages of user ranks are used, and the rank becomes higher in the order of C<B<A<S′<S. Conditions are imposed with respect to assignment of each rank.

In the example illustrated in FIG. 8, a rank C is assigned when the annual use records indicate less than 10 times. A rank B is assigned when the annual use records indicate 10 times or more and less than 50 times. A rank A is assigned when the annual use records indicate 50 times or more and less than 100 times. A rank S′ is assigned for a first-time user. A rank S is assigned when the annual use records indicate 100 times or more.

The higher the rank, a higher priority one can receive in matching. For example, in the case where ride reservation requests with approximately same schedule information are received from a ride-seeking user #1 of the rank A and a ride-seeking user #2 of the rank S, the ride-seeking user #2 of the rank S may be preferentially matched or may be matched with a better driver user. Furthermore, a more luxurious vehicle 10 may be allocated, the higher the member rank. Moreover, the fee that the ride-seeking user is to pay may be more reduced, the higher the member rank. In the case of the driver user, the driver user may be matched with a greater number of ride-seeking users, the higher the member rank.

Furthermore, the member rank may be changed according to the annual cancellation records. For example, the member rank is lowered by one level when the number of times indicated by the annual cancellation records reaches or exceeds ten. Moreover, lowering of the member rank according to the annual cancellation records may be made a penalty at the time of cancellation of a ride reservation.

<Flow of Processing>

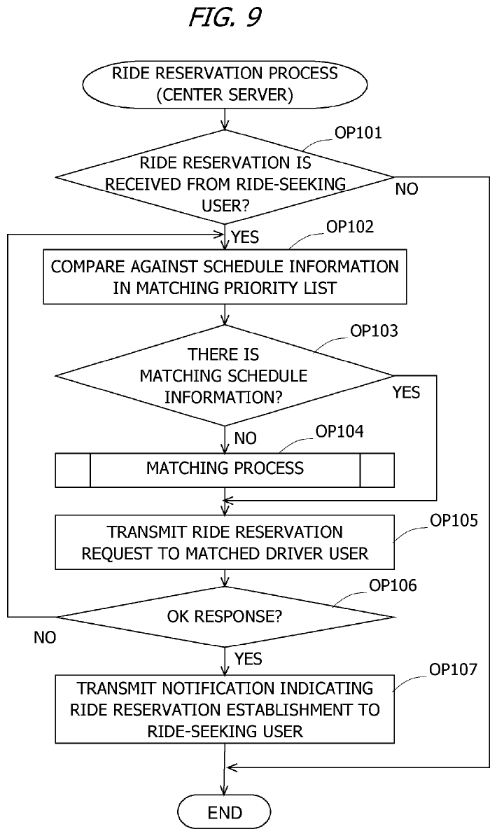

FIG. 9 is an example of a flowchart of a ride reservation process by the center server 100 according to the first embodiment. The process illustrated in FIG. 9 is repeated every predetermined period, for example. A performer of the process illustrated in FIG. 9 is the processor 101 of the center server 100, but for the sake of convenience, a description will be given taking the reservation processing unit 11, which is a functional structural element, as the performer. The same applies to subsequent flowcharts of processes by the center server 100.

In OP101, the reservation processing unit 11 determines whether or not a ride reservation request is received from the user terminal 200B of the ride-seeking user through the terminal communication unit 13. In the case where a ride reservation request is received from the user terminal 200B of the ride-seeking user (OP101: YES), the process proceeds to OP102. In the case where a ride reservation request is not received (OP101: NO), the process illustrated in FIG. 9 is ended.

In OP102, the reservation processing unit 11 compares the schedule information on the ride-seeking user, which is received together with the ride reservation request, against the schedule information in the matching priority list 19. In OP103, the reservation processing unit 11 determines whether or not there is schedule information, in the matching priority list 19, that is similar to the schedule information on the ride-seeking user.

In the case where schedule information that is similar to the schedule information on the ride-seeking user exists in the matching priority list 19 (OP103: YES), the reservation processing unit 11 matches the driver user who is associated with the schedule information in the matching priority list 19 with the ride-seeking user of the ride reservation request. In the case where there are a plurality of schedule information pieces, in the matching priority list 19, that are similar to the schedule information on the ride-seeking user, matching with the driver user who is associated with the schedule information at the top of the matching priority list 19 is performed, for example. Information on the matched driver user is deleted from the matching priority list 19. Then, the process proceeds to OP105.

In the case where there is no schedule information, in the matching priority list 19, that is similar to the schedule information on the ride-seeking user (OP103: NO), the process proceeds to OP104. In OP104, the reservation processing unit 11 requests the matching processing unit 12 to perform matching for the ride-seeking user of the ride reservation request, and the matching-counterpart driver user, the scheduled meet-up location, the scheduled meet-up time, and the like are determined by the matching processing unit 12.

In OP105, the reservation processing unit 11 transmits the ride reservation request to the user terminal 200A of the matched driver user, through the terminal communication unit 13. In OP106, the reservation processing unit 11 determines whether or not an OK response for the ride reservation request is received from the user terminal 200A of the driver user. In the case where an OK response to the ride reservation request is received from the user terminal 200A of the driver user (OP106: YES), the process proceeds to OP107. For example, in the case where an OK response for the ride reservation request is not received from the user terminal 200A of the driver user after a lapse of a predetermined period or in the case where an NG response is received from the user terminal 200A (OP106: NO), the process proceeds to OP102, and the process is performed again from comparison with the matching priority list 19.

In OP107, the reservation processing unit 11 transmits a notification indicating ride reservation establishment to the user terminal 200B of the ride-seeking user who is the transmission source of the ride reservation request, through the terminal communication unit 13. Furthermore, the reservation processing unit 11 stores ride reservation information in the reservation information DB 17. Then, the process illustrated in FIG. 9 is ended. Additionally, the process for when a ride reservation request is received is not limited to the process illustrated in FIG. 9.

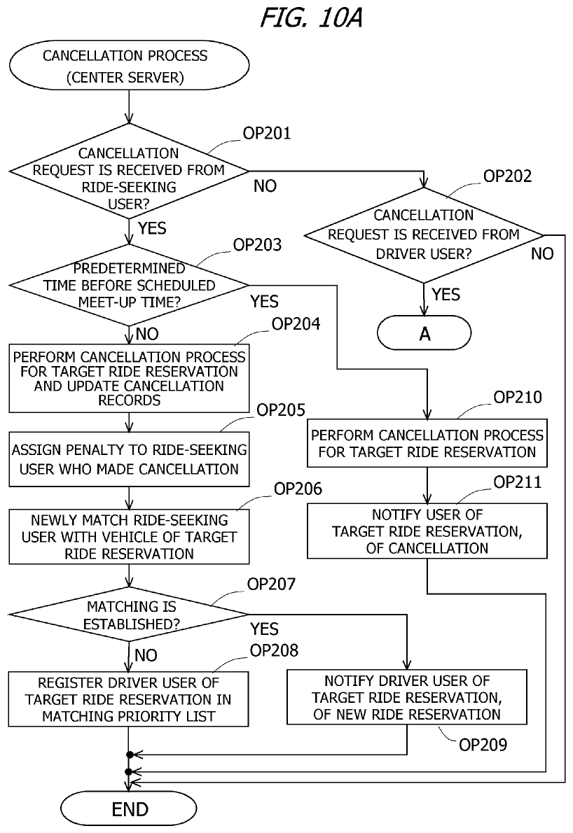

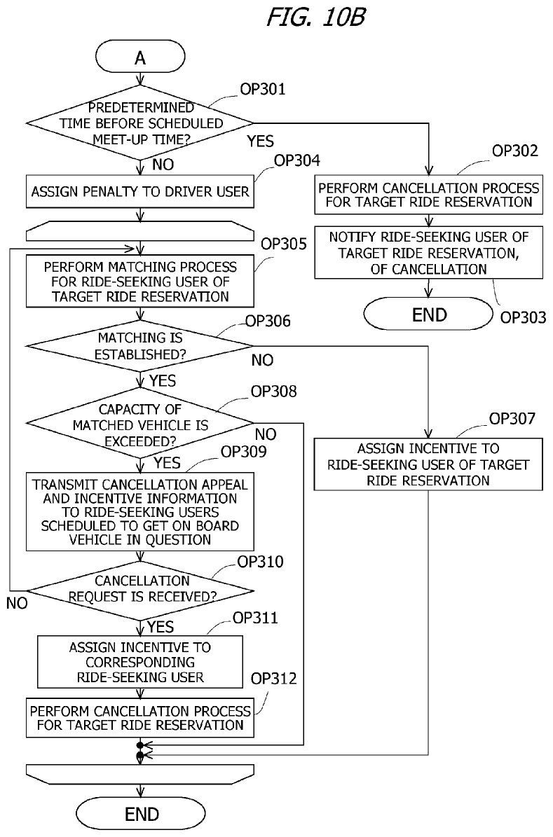

FIGS. 10A and 10B are diagrams illustrating an example of a flowchart of a cancellation process by the center server 100 according to the first embodiment. The cancellation process is a process for when a cancellation request for a ride reservation is received from the user terminal 200. The processes illustrated in FIGS. 10A and 10B are repeated every predetermined period, for example.

In OP201, the reservation processing unit 11 determines whether or not a cancellation request from a ride reservation is received from the user terminal 200B of the ride-seeking user through the terminal communication unit 13. In the case where a cancellation request for a ride reservation is received from the user terminal 200B of the ride-seeking user (OP201: YES), the process proceeds to OP203. In the case where a cancellation request for a ride reservation is not received from the user terminal 200B of the ride-seeking user (OP201: NO), the process proceeds to OP202.

In OP202, the reservation processing unit 11 determines whether or not a cancellation request for a ride reservation is received from the user terminal 200A of the driver user through the terminal communication unit 13. In the case where a cancellation request for a ride reservation is received from the user terminal 200A of the driver user (OP202: YES), the process proceeds to OP301 in FIG. 10B. In the case where a cancellation request for a ride reservation is not received from the user terminal 200A of the driver user (OP202: NO), the process illustrated in FIG. 10A is ended.

Processes from OP203 to OP211 are processes for when a cancellation request for a ride reservation is received from the user terminal 200B of the ride-seeking user. In OP203, the reservation processing unit 11 determines whether or not it is a predetermined time before the scheduled meet-up time of the ride reservation which is the target of the cancellation request. In the case where it is a predetermined time before the scheduled meet-up time of the target ride reservation (OP203: YES), the process proceeds to OP210. In the case where a time point that is a predetermined time before the scheduled meet-up time of the target ride reservation is already passed (OP203: NO), the process proceeds to OP204.

Processes from OP204 to OP209 are processes that are performed when a time point that is a predetermined time before the scheduled meet-up time of the ride reservation which is the target of the cancellation request is already passed. In OP204, the reservation processing unit 11 performs a cancellation process for the target ride reservation. Specifically, the reservation processing unit 11 deletes information about the target ride reservation from the reservation information DB 17, and deletes the schedule information on the corresponding ride-seeking user from the ride-seeking user schedule information DB 15. Furthermore, the reservation processing unit 11 notifies the user terminal 200A of the driver user of the target ride reservation and the user terminal 200B of the ride-seeking user who is the transmission source of the cancellation request, of cancellation of the ride reservation, through the terminal communication unit 13. Moreover, in OP204, the reservation processing unit 11 updates the value in the field of annual cancellation records in the user information DB 14, for the ride-seeking user who is the transmission source of the cancellation request.

In OP205, the reservation processing unit 11 assigns a penalty to the ride-seeking user who is the transmission source of the cancellation request for the ride reservation. Contents of the penalty are as described above. The reservation processing unit 11 may notify the user terminal 200B of the ride-seeking user of the penalty that is assigned to the ride-seeking user, or may record the same in the user information DB 14, for example. In OP206, the reservation processing unit 11 requests the matching processing unit 12 to perform matching for the driver user of the ride reservation which is the target of the cancellation request.

In OP207, the reservation processing unit 11 determines whether or not a ride-seeking user to be newly matched is found in the matching for the driver user of the ride reservation which is the target of the cancellation request. In the case where a ride-seeking user to be newly matched is found (OP207: YES), the process proceeds to OP209. In the case where a ride-seeking user to be newly matched is not found (OP207: NO), the process proceeds to OP208. Additionally, matching in OP207 is performed with respect to a ride-seeking user who is a transmission source of a ride reservation request and who is not matched with any driver user. However, such a case is not restrictive, and matching may also be performed taking, as a matching target, a ride-seeking user for whom a ride reservation is established with a driver user of a low member rank.

In OP208, the reservation processing unit 11 registers, in the matching priority list 19, the driver user of the ride reservation which is the target of the cancellation request, and the schedule information on the ride reservation. Accordingly, in the case where a ride reservation request with schedule information similar to that of the cancelled ride reservation is thereafter received, the driver user in question is preferentially matched (see FIG. 9). Additionally, in OP208, the reservation processing unit 11 may notify the user terminal 200A of the driver user of the ride reservation which is the target of the cancellation request, of registration in the matching priority list 19. Then, the process illustrated in FIG. 10A is ended.

In OP209, because a ride-seeking user who is to be newly matched is found in the matching for the driver user of the ride reservation which is the target of the cancellation request, the reservation processing unit 11 establishes the ride reservation for the matching. Furthermore, the reservation processing unit 11 notifies the user terminal 200A of the driver user of the ride reservation which is the target of the cancellation request, of establishment of a new ride reservation, through the terminal communication unit 13. Then, the process illustrated in FIG. 10A is ended.

Processes in OP210 and OP211 are processes that are performed when a reception time point of the cancellation request is a predetermined time before the scheduled meet-up time of the target ride reservation. In OP210, the reservation processing unit 11 performs a cancellation process for the ride reservation which is the target of the cancellation request. The cancellation process performed in OP210 is the same as the cancellation process that is performed in OP204. In OP211, the reservation processing unit 11 notifies the user terminal 200A of the driver user of the target ride reservation and the user terminal 200B of the ride-seeking user, of cancellation of the ride reservation, through the terminal communication unit 13. Then, the process illustrated in FIG. 10A is ended.

The process illustrated in FIG. 10B is a process for when a cancellation request for a ride reservation is received from the user terminal 200A of the driver user. Identification information on the cancellation-target ride reservation is also received together with the cancellation request for the ride reservation from the user terminal 200A of the driver user. In the case where a plurality of ride-seeking users are to get on board in one transport by the vehicle 10, there are a plurality of ride reservations which are the cancellation targets of the driver user.

In OP301, the reservation processing unit 11 determines whether or not it is a predetermined time before the scheduled meet-up time of the ride reservation which is the target of the cancellation request. In the case where it is a predetermined time before the scheduled meet-up time of the target ride reservation (OP301: YES), the process proceeds to OP302. In the case where a time point that is a predetermined time before the scheduled meet-up time of the target ride reservation is already passed (OP301: NO), the process proceeds to OP304.

Processes in OP302 and OP303 are processes that are performed when a reception time point of the cancellation request is a predetermined time before the scheduled meet-up time of the target ride reservation. The reservation processing unit 11 performs the cancellation process for the ride reservation which is the target of the cancellation request (OP302), and notifies the user terminal 200B of the ride-seeking user of the target ride reservation, of cancellation of the ride reservation, through the terminal communication unit (OP303). Then, the process illustrated in FIG. 10B is ended. Additionally, in the case where there are a plurality of ride reservations that are cancellation targets of the driver user (i.e., in the case where a plurality of ride-seeking users are to get on board in one transport by the vehicle 10), the cancellation process and notification to the ride-seeking user of the cancellation are performed for each ride reservation.

Processes from OP304 to OP312 are processes that are performed when a time point that is a predetermined time before the scheduled meet-up time of the ride reservation which is the target of the cancellation request is already passed. In OP304, the reservation processing unit 11 assigns a penalty to the driver user who is the transmission source of the cancellation request for the ride reservation. Contents of the penalty are as described above. The reservation processing unit 11 may notify the user terminal 200A of the driver user of the penalty that is assigned to the driver user, or information about the penalty that is assigned to the driver user may be recorded in the user information DB 14, for example.

Processes from OP305 to OP312 are processes for one ride-seeking user of one ride reservation, and are performed for each ride-seeking user of the cancellation-target ride reservation. In the following, the ride-seeking user who is the target of the processes from OP305 to OP312 will be referred to as the target ride-seeking user.

In OP305, the reservation processing unit 11 requests the matching processing unit 12 to perform matching for the target ride-seeking user. The matching processing unit 12 performs matching for the target ride-seeking user, also taking into account the vehicle 10 for which the capacity is already reached by the ride-seeking users who are scheduled to get on board. However, such a case is not restrictive, and the vehicle 10 for which the capacity is already reached by the ride-seeking users who are scheduled to get on board may be excluded from the targets of matching.

In OP306, the reservation processing unit 11 determines whether or not a matching-counterpart vehicle 10 is determined for the target ride-seeking user. In the case where a matching-counterpart vehicle 10 is determined for the target ride-seeking user (OP306: YES), the process proceeds to OP308. In the case where a matching-counterpart vehicle 10 is not determined for the target ride-seeking user (OP306: NO), the process proceeds to OP307.

In OP307, because matching is not established, the reservation processing unit 11 assigns a predetermined incentive to the target ride-seeking user. Then, the processes are performed from OP305 for another ride-seeking user of the cancellation-target ride reservation, or the process illustrated in FIG. 10B is ended.

In OP308, the reservation processing unit 11 determines whether or not the capacity of the vehicle 10 that is newly matched with the target ride-seeking user is exceeded. In the case where the capacity of the vehicle 10 that is newly matched with the target ride-seeking user is exceeded (OP308: YES), the process proceeds to OP309. In the case where the capacity of the vehicle 10 that is newly matched with the target ride-seeking user is not exceeded (OP308: NO), the reservation processing unit 11 establishes a ride reservation according to the matching, and transmits a notification indicating ride reservation establishment to the user terminal 200B of the target ride-seeking user. Then, the processes are performed from OP305 for another ride-seeking user of the cancellation-target ride reservation, or the process illustrated in FIG. 10B is ended.

In the following, the vehicle 10 that is newly matched with the target ride-seeking user, and the capacity of which is exceeded will be referred to as the target vehicle 10.

In OP309, the reservation processing unit 11 transmits, to the user terminals 200B of all the ride-seeking users who are scheduled to get on board the target vehicle 10, a cancellation appeal and information about an incentive that is assigned in a case where cancellation is made. This is a process for recruiting a ride-seeking user who is willing to cancel the ride reservation, performed due to the capacity of the target vehicle 10 being exceeded. Information about all the ride-seeking users who are scheduled to get on board the target vehicle 10 is acquired from the reservation information DB 17, for example. Identification information on the cancellation-target ride reservation is also transmitted together with the cancellation appeal. In the following, the ride-seeking user who is scheduled to get on board the target vehicle 10, and who is the transmission destination of the cancellation appeal will be referred to as a cancellation appeal-target user.

In OP310, the reservation processing unit 11 determines whether or not a cancellation request for the ride reservation is received in response to the cancellation appeal, from any of the user terminals 200B of the cancellation appeal-target users. In the case where a cancellation request for the ride reservation is received in response to the cancellation appeal, from any of the user terminals 200B of the cancellation appeal-target users (OP310: YES), the process proceeds to OP311. For example, in the case where a cancellation request for the ride reservation is not received from any of the user terminals 200B of the cancellation appeal-target users even after a lapse of a predetermined time from transmission of the cancellation appeal (OP310: NO), the process proceeds to OP305, and matching is performed again.

In OP311, the reservation processing unit 11 assigns an incentive to the cancellation appeal-target user who is the transmission source of the cancellation request for the ride reservation, reception of which is detected in OP308. Contents of the incentive are as described above. The reservation processing unit 11 may notify the user terminal 200B of the cancellation appeal-target user in question of the incentive that is assigned to the cancellation appeal-target user, or may record the same in the user information DB 14, for example.

In OP312, the reservation processing unit 11 performs a cancellation process for the ride reservation which is the target of the cancellation request for the ride reservation, reception of which is detected in OP308. Contents of the cancellation process for the ride reservation are the same as those in OP204 in FIG. 10A. Furthermore, the reservation processing unit 11 transmits a notification indicating ride reservation cancellation to the user terminal 200A of the driver user of the target vehicle 10 and the user terminal 200B of the cancellation appeal-target user who is the transmission source of the cancellation request for the ride reservation, reception of which is detected in OP308. The processes from OP305 are performed for another ride-seeking user of the cancellation-target ride reservation, or the process illustrated in FIG. 10B is ended.

Additionally, the processes, by the center server 100, for a case where a cancellation request for a ride reservation is received, illustrated in FIGS. 10A and 10B, are examples, and are not restrictive.

### Operations and Effects of First Embodiment

In the first embodiment, in the case where there is a cancellation request for a ride reservation from a driver user or a ride-seeking user, the center server 100 matches a substitute driver user or a substitute ride-seeking user with the ride-seeking user or the driver user of the ride reservation. An influence on the schedule of the user who receives cancellation of the ride reservation may thereby be reduced. Moreover, the center server 100 assigns a penalty to the driver user or the ride-seeking user who is the transmission source of the cancellation request. Inconsiderate cancellation of a ride reservation by a driver user or a ride-seeking user may thereby be suppressed.

Furthermore, in the first embodiment, in the case where a substitute driver user or a substitute ride-seeking user, as a matching counterpart, is not found for the ride-seeking user or the driver user who received cancellation of the ride reservation, the center server 100 assigns an incentive to the ride-seeking user or the driver user. A damage caused by cancellation of a ride reservation may thereby be compensated for, and reduction in the willingness to use the ride-sharing service may be suppressed.

Furthermore, in the first embodiment, in the case where there is a cancellation of a ride reservation from a driver user, the center server 100 performs matching of a substitute driver user (vehicle 10) for the ride-seeking user of the ride reservation. In the case where the capacity of a matched vehicle 10 will be exceeded by boarding of the ride-seeking user in question, the center server 100 transmits a cancellation appeal for the ride reservation for the vehicle 10, to the user terminals 200B of other ride-seeking users who are scheduled to get on board the matched vehicle 10. A ride-seeking user who is willing to give up boarding the vehicle 10 may thereby be recruited from the ride-seeking users who are scheduled to get on board the matched vehicle 10. Because an incentive is assigned to a ride-seeking user who cancels a ride reservation in response to a cancellation appeal, the cancellation appeal is more easily met.

### Other Embodiments

The embodiment described above is an example, and the present disclosure may be changed and carried out as appropriate without departing from the gist of the present disclosure.

In the first embodiment, in the case where there is a cancellation of a ride reservation from a driver user, the center server 100 performs matching of a substitute driver user (vehicle 10) for the ride-seeking user of the ride reservation, and in the case where the capacity of a matched vehicle 10 will be exceeded by boarding of the ride-seeking user in question, the center server 100 transmits a cancellation appeal to the user terminals 200B of other ride-seeking users who are scheduled to get on board the matched vehicle 10. Alternatively, the ride-seeking users who are made the transmission destinations of the cancellation appeal may be limited to users of the lowest rank among the ride-seeking users who are scheduled to get on board the matched vehicle 10, for example. A preferential treatment that a ride reservation is less likely to be cancelled may thereby be offered to a ride-seeking user of a high member rank.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a processor configured to:
manage reservation for a transport service for sharing a ride in a vehicle that travels to a predetermined destination;
receive a cancellation request for a first reservation for the transport service provided using a first vehicle, from a user terminal of a first user who is one of a driver user of the first vehicle or a passenger user who is scheduled to get on board the first vehicle, for whom the first reservation is established; and
determine a substitute driver user or a substitute passenger user for the first user, and assign a penalty to the first user, in a case where the cancellation request for the first reservation is received from the user terminal of the first user.

2. The information processing apparatus according to claim 1, wherein the penalty is any of cancellation charges, a reduction or an increase in a fee for subsequent use of the transport service, and a lower priority ranking for reservation for the transport service.

3. The information processing apparatus according to claim 1, wherein, in a case where a substitute user for the first user is not found, the processor is configured to assign an incentive to a user receiving cancellation of the first reservation.

4. The information processing apparatus according to claim 1, wherein
in a case where the first user is the driver user, the control unit determines, as the substitute driver user for the first user, a driver user of a second vehicle on which a first passenger user of the first reservation is to board, and
in a case where capacity of the second vehicle is to be exceeded by boarding of the first passenger user on the second vehicle, the processor is configured to transmit, to a user terminal of a second passenger user for whom a second reservation for boarding the second vehicle is established, a cancellation appeal for the second reservation and information about an incentive that is assigned to the second passenger user in a case of cancellation of the second reservation.

5. The information processing apparatus according to claim 3, wherein the incentive is any of a higher priority ranking for reservation for the transport service, and assignment of a point or a coupon.

6. An information processing system including one or a plurality of processors configured to:
manage reservation for a transport service for sharing a ride in a vehicle that travels to a predetermined destination;
receive a cancellation request for a first reservation for the transport service provided using a first vehicle, from a user terminal of a first user who is one of a driver user of the first vehicle or a passenger user who is scheduled to get on board the first vehicle, for whom the first reservation is established; and
determine a substitute driver user or a substitute passenger user for the first user, and assign a penalty to the first user, in a case where the cancellation request for the first reservation is received from the user terminal of the first user.

7. An information processing method including:
managing reservation for a transport service for sharing a ride in a vehicle that travels to a predetermined destination;
receiving a cancellation request for a first reservation for the transport service provided using a first vehicle, from a user terminal of a first user who is one of a driver user of the first vehicle or a passenger user who is scheduled to get on board the first vehicle, for whom the first reservation is established; and
determining a substitute driver user or a substitute passenger user for the first user, and assigning a penalty to the first user, in a case where the cancellation request for the first reservation is received from the user terminal of the first user.
